(19) United States
(12) Patent Application Publication
(10) Pub. No.: US 2023/0222099 A1
(43) Pub. Date: Jul. 13, 2023

(54) POLICY DRIVEN EVENT TRANSFORMATION

(71) Applicant: RAKUTEN MOBILE, INC., Tokyo (JP)

(72) Inventors: Jyoti BOSE, Mumbai (IN); Mihirraj Narendra DIXIT, Tokyo (JP); Surender Singh LAMBA, Tokyo (JP); Abhishek SHARMA, Tokyo (JP)

(21) Appl. No.: 17/574,552

(22) Filed: Jan. 13, 2022

(51) Int. Cl. G06F 16/172; G06F 16/2455

(52) U.S. Cl. CPC G06F 16/172; G06F 16/24552

(57) ABSTRACT

A system includes processing circuitry; and a memory connected to the processing circuitry, wherein the memory is configured to store executable instructions that, when executed by the processing circuitry, facilitate performance of operations, including: receive an event message frame from a data source, wherein the event message frame is generated by one or more state changes within a network operatively connected to the system; correlate one or more business policies based the event message frame; apply the one or more operations to the event message frame based on the one or more business policies to create a transformed event message frame; and route the transformed event message frame to a message queue.

### BACKGROUND

Event-driven architecture (EDA) is a software architecture promoting the production, detection, consumption of, and reaction to events. An event is a change in state or an annotated label based on an entities log output in a system. For example, when a consumer purchases an online product, the product's state changes from “for sale” to “sold”. A seller's system architecture treats this state change as an event whose occurrence is made known to other applications within the architecture. What is produced, published, propagated, detected or consumed is a message called the event notification, and not the event, which is the state change that triggered the message emission. Events occur and event messages are generated and propagated to report the event that occurred. Nevertheless, the term event is often used metonymically to denote the notification event message. The EDA is often designed atop message-driven architectures, where such a communication pattern includes one of the inputs to be text-based (e.g., the message) to differentiate how each communication is handled.

On the fly is a phrase used to describe something that is being changed while the process that the change affects is ongoing. In computing, on the fly is used in programming to describe changing a program while the program is still running.

### BRIEF DESCRIPTION OF THE DRAWINGS

Aspects of the present disclosure are best understood from the following detailed description when read with the accompanying FIGS. In accordance with the standard practice in the industry, various features are not drawn to scale. In fact, the dimensions of the various features are arbitrarily increased or reduced for clarity of discussion.

FIG. 1 is a block diagram representation of an event transformation system, in accordance with some embodiments.

FIG. 2 is s flow diagram for a method of transforming event message frame(s), in accordance with some embodiments.

FIG. 3 is a high-level functional block diagram of an event transformer processor-based system, in accordance with some embodiments.

### DETAILED DESCRIPTION

The following disclosure includes many different embodiments, or examples, for implementing different features of the subject matter. Specific examples of components, values, operations, materials, arrangements, or the like, are described below to simplify the present disclosure. These are, of course, merely examples and are not intended to limit. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are not in direct contact. In addition, the present disclosure repeats reference numerals and/or letters in the various examples. This repetition is for the purpose of simplicity and clarity and does not in dictate a relationship between the various embodiments and/or configurations discussed.

Further, spatially relative terms, such as “beneath,” “below,” “lower,” “above,” “upper” and the like, are usable herein for ease of description to describe one element or feature's relationship to another element(s) or feature(s) as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors usable herein likewise are interpreted accordingly.

An EDA architectural pattern is applied by the design and implementation of applications and systems that transmit event messages among loosely coupled software components and services. An event-driven system typically consists of event emitters (or agents, data sources), event consumers (or sinks), and event channels (or the medium the event messages travel from emitter to consumer). Event emitters detect, gather, and transfer event messages. An event emitter does not know the consumers of the event messages, the event emitter does not even know if an event consumer exists, and in case the event consumer exists, the event emitter does not know how the event message is used or further processed. Event consumers apply a reaction as soon as an event message is presented. The reaction is or is not completely provided by the event consumer. For example, the event consumer filters the event message frame(s) while the event policy execute and producer transforms and forwards the event message frame(s) to another component or the event consumer supplies a self-contained reaction to such event message frame(s). Event channels are conduits in which event message frame(s) are transmitted from event emitters to event consumers. In some embodiments, event consumers become event emitters after receiving event message frame(s) and then forwarding the event message frame(s) to other event consumers. The configuration of the correct distribution of event message frame(s) is present within the event channel. The physical implementation of event channels is based on components, such as message-oriented middleware or point-to-point communication, which might rely on a more appropriate transactional executive framework (such as a configuration file that establishes the event channel).

In some embodiments, a universal data transformer correlates event message frame(s) with business policy. In some embodiments, a universal data transformer is configured for dynamic plug and play. In some embodiments, the universal data transformer is configured for a correlation and policy engine (CPE). In computing, data transformation is the process of converting data from one format or structure into another format or structure. Data transformation is an aspect of data integration and data management tasks such as data wrangling, data warehousing, data integration and application integration.

A CPE is a software application that programmatically understands relationships. CPEs are configured to be used in system management tools to aggregate, normalize and analyze event data. Event correlation is a technique for making sense of a large number of events and pinpointing the few events that are important in a mass of information. This is accomplished by looking for and analyzing relationships between events. Further, a CPE is a program or process that is able to receive machine-readable policies and apply them to a particular problem domain to constrain the behavior of network resources.

In other approaches, the CPE has tightly bound capabilities that limits the CPE. For example, multiple use-cases used by tightly bound systems, include: (1) a change management system; (2) a root cause analysis engine (performed in real time), (3) an anomaly detection model engine (performed in real time), (4) an AI model performance engine (performed in real time), (5) a performance analysis engine, (6) a security analytics engine, (7) an on the fly policy load/change engine. In some embodiments, a generic and universal data transformer is able to correlate one or more policies to one or more use-cases, such as those mentioned directly above.

Change management systems are an information technology (IT) service management discipline. The objective of change management is to ensure that standardized methods and procedures are used for efficient and prompt handling of all changes to control IT infrastructure, in order to minimize the number and impact of any related incidents upon service. Changes in the IT infrastructure arise reactively in response to problems or externally imposed requirements, e.g., legislative changes, or proactively from seeking improved efficiency and effectiveness or to enable or reflect business initiatives, or from programs, projects or service improvement initiatives. Change management ensures standardized methods, processes and procedures which are used for all changes, facilitate efficient and prompt handling of all changes, and maintain the proper balance between the need for change and the potential detrimental impact of changes.

A root cause analysis engine is an algorithm developed to provide an automated version of root cause analysis, the method of problem solving that tries to identify the root causes of faults or problems. The algorithm is configured to be used for inaccurate or inconsistent data, incomplete data, large amounts of data, small datasets, and complex problems such as multi-modal failures or with more than one solution.

In data analysis, anomaly detection (also known as outlier detection) is the identification of rare items, events or observations which raise suspicions by differing significantly from the majority of the data. Typically the anomalous items translate to some kind of problem. Anomalies are also referred to as outliers, novelties, noise, deviations and exceptions. In particular, in the context of abuse and network intrusion detection, the interesting objects are often not rare objects, but unexpected bursts in activity. This pattern does not adhere to the common statistical definition of an outlier as a rare object, and many outlier detection methods (in particular unsupervised methods) fail on such data, unless it has been aggregated appropriately.

AI model performance engines monitor AI models for changes such as model degradation, data drift, and concept drift, to ensure the AI model is maintaining an acceptable level of performance.

A performance analysis engine identifies whether service performance targets are being achieved, and where relevant, to provide verifiable evidence; alerts when service performance is degrading, especially when service performance falls below targets; provides information that helps analyze situations, identify locations, scales and variances of performance problems, and support information for proposed remedial action; and tracks the impacts of interventions and remedial measures.

Security analytics engines use both real-time and historical data to detect and diagnose threats. Sources of information include: real-time alerts from workstations, servers, sensors, mobile devices, and other endpoints; real-time feeds from other IT security applications (firewalls, intrusion prevention, endpoint detection and response, and other suitable security applications.); network traffic volume and types; server logs; and third-party threat intelligence feeds. Security analytics combines data from the various sources and looks for correlations and anomalies within the data.

On the fly policy load/change services periodically download policy and data from servers. The policies and data are loaded on the fly without requiring a restart. Once the policies and data have been loaded, they are enforced immediately. On the fly policy load/change services ensure up-to-date policies and data.

In some embodiments, a universal event transformer correlates and embeds multiple policies based on multiple use-cases based on received events. In some embodiments, the policies are correlated and embedded with the event frame(s). In some embodiments, an event transformer performs complex and real time event processing. In some embodiments, this processing is ordered (by order of their occurrence). In some embodiments, this processing is non-ordered (e.g., permutation based; changing a linear order of an ordered set). In some embodiments, the universal event transformer is configured to correlate event messages with one or more policies based on one or more use-cases. In some embodiments, this processing is a pattern matching system.

In computer science, pattern matching is the act of checking a given sequence of tokens for the presence of the constituents of some pattern. In contrast to pattern recognition, the match usually has to be exact: either it will or will not be a match. The patterns generally have the form of either sequences or tree structures. Uses of pattern matching include outputting the locations (if any) of a pattern within a token sequence, to output some component of the matched pattern, and to substitute the matching pattern with some other token sequence (i.e., search and replace). Parsing algorithms often rely on pattern matching to transform strings into syntax trees

Event processing is a method of tracking and analyzing (e.g., processing) streams of information (e.g., data) about things that happen (events), and deriving a conclusion from them. Complex event processing, or CEP, consists of a set of concepts and techniques for processing real-time events and extracting information from event streams as they arrive. The goal of CEP is to identify meaningful events (such as opportunities or threats) in real-time situations and respond to them as quickly as possible.

In some embodiments, a universal event transformer is configured to correlate one or more operations, such as: mapping, filtering, windowing, interpolation, reduction, accumulation, and aggregation to one or more policies.

In computing and data management, data mapping is the process of creating data element mappings between two distinct data models. Data mapping is used as a first step for a wide variety of data integration tasks, including: (1) data transformation or data mediation between a data source and a data sink; (2) identification of data relationships as part of data lineage analysis; (3) discovery of hidden sensitive data; and (4) consolidation of multiple databases into a single database and identifying redundant columns of data for consolidation or elimination.

A data filter is a computer program or subroutine to process a data stream that produces another data stream. While a single filter is used individually, they are frequently strung together to form a pipeline. A data filter, as the name suggests, are used to filter data for desired data elements.

Windowing is a processing method for streams of data. Windowing takes an unbounded stream of data (events) and splits the data into finite sets, or windows, based on specified criteria, such as time. A window is an in-memory table in which events are added and removed based on a set of policies.

Interpolation is a type of estimation, a method of constructing (e.g., finding) new data points based on the range of a discrete set of known data points. In systems with a large number of data points, obtained by sampling or experimentation, which represent the values of a function for a limited number of values of the independent variable, interpolation is used to estimate the value of that function for an intermediate value of the independent variable.

In functional programming, fold (also termed reduce, accumulate, aggregate, compress, or inject) refers to a family of higher-order functions that analyze a recursive data structure and through use of a given combining operation, recombine the results of recursively processing its constituent parts, building up a return value. Typically, a fold is presented with a combining function, a top node of a data structure, and possibly some default values to be used under certain conditions. The fold then proceeds to combine elements of the data structure's hierarchy, using the function in a systematic way.

In some embodiments, a universal event transformer is configured with multiple policies for multiple use-cases. In some embodiments, operations of a universal event transformer are modified based upon policy information and the event transformer processes incoming events per the user implemented policy information. In some embodiments, operations of a universal event transformer are modified on the fly based on a changed policy and thus the policy takes effect immediately.

In some embodiments, a universal event transformer processes complex pipelines identified in policies and achieves 5G (fifth generation broadband standard) SLA (service level agreement) of 5 ms for processing speed.

In some embodiments, a plug and play daemon process formats event message frame(s) with one or more policies based on one or more use-cases. In multitasking computer operating systems, a daemon process is a computer program that functions as a background process rather than being under the direct control of an interactive user. Systems often start daemon processes at boot time that respond to network requests, hardware activity, or other programs by performing a task.

Framing is a technique to place data into discernible blocks of information. In some embodiments, framing is a way for a sender (e.g., a data source) to transmit a set of bits that are meaningful to the receiver (e.g., a data sink).

In programming and software design, an event is a change of state (e.g., an action or occurrence) recognized by software, often originating asynchronously from the external environment that is handled by the software. Computer event messages are generated or triggered by a system, by a user, or in other ways based upon the event. Event messages are handled synchronously with the program flow; that is, the software is configured to have one or more dedicated places (e.g., a data sink) where event messages are handled. A source of event messages includes the user, who interacts with the software through the computer's peripherals; for example, by typing on a keyboard. Another source is a hardware device such as a timer. Software is configured to further trigger the software's own set of event messages into the event channel (e.g. to communicate the completion of a task). Software that changes behavior in response to event messages is said to be event-driven, often with the goal of being interactive.

In some embodiments, an event transformer is a daemon service that loads business data into a shared cache in Eager mode (e.g., all on one query in contrast to Lazy mode). In some embodiments, an event gate is a pluggable data adaptor that connects with multiple types of data sources to collect data, such as event messages, process the event messages into frames, and forward the event message frame(s) directly or indirectly to the event transformer. In some embodiments, the event messages are collected via a data stream, batch data, online data, and offline data. In some embodiments, the event gate frames collect event messages based on business logic stored in a master database. In computer software, business logic, business layer, business policy, or domain logic is the part of a software program that encodes the real-world business rules that determine how data is created, stored, and changed. Business logic is contrasted with the remainder of the software program, such as the technical layer or service layer that is concerned with lower-level details of managing a database or displaying the user interface, system infrastructure, or generally connecting various parts of the program.

The event gate is a data adapter and functions as a bridge between a data source and a disconnected data class, such as a data set. In some embodiments, the event gate supplies collected and framed event messages to an event transformer that embeds one or more policies based on one or more use-cases with the event messages and then routes the framed event messages to a data sink where the event messages are processed based upon the one or more policies. In a data transformation stage, a series of rules, policies, or functions are applied to the event messages in order to prepare the event messages for loading into a data sink. For example, event messages are processed using CEP processing or pattern matching processing. Further, the even messages have operations performed such as mapping, filtering, windowing, interpolation, reduction, accumulation, or aggregation to find the event messages of interest.

The event gate is used to exchange data between a data source and the event transformer. In many applications, this means reading data from a database into a dataset, and then writing changed data from the dataset to the event transformer. In some embodiments, the event gate routes the data through an intermediary process before the event transformer. For example, the event gate routes event message frames through an event enricher which associates the message frames with other events related to the event message frame.

In some embodiments, the event gate connects data sources to collect data in a stream. A stream is thought of as items on a conveyor belt being processed one at a time rather than in large batches. Streams are processed differently from batch data. Normal functions do not operate on streams as a whole as the streams have potentially unlimited data; streams are co-data (potentially unlimited), not data (which is finite). Functions that operate on a stream, producing another stream, are known as filters, and are connected in pipelines, analogous to function composition. Filters operate on one item of a stream at a time, or base an item of output on multiple items of input, such as a moving average. Computerized batch processing is processing without end user interaction, or processing scheduled to run as resources permit.

In some embodiments, an event transformer embeds one or more business policies based on one or more use-cases within event message frame(s) received from an event gate. In some embodiments, the event transformer transforms the event message frame(s) in real time, by embedding the one or more business policies. In some embodiments, the event transformer distributes or routes the transformed event message frame(s) to a downstream process; often times a data sink. In some embodiments, the transformed event message frame(s) are produced over a real-time messaging queue or other suitable communication protocol in accordance with some embodiments.

Real-time or real time describes operations in computing or other processes that guarantee response times within a specified time (deadline), usually a relatively short time. A real-time process is generally one that happens in defined time steps of maximum duration and fast enough to affect the environment in which the real-time process occurs, such as inputs to a computing system. In computer science, message queues and mailboxes are software-engineering components typically used for inter-process communication (IPC), or for inter-thread communication within the same process. Message queues use a queue for messaging; the passing of control or of content. In a computer network, downstream refers to data sent from a provider to a consumer. One process sending data primarily in the downstream direction is downloading. In some embodiments, downstream refers to the direction from a shared queue to an event consumer.

The business layer contains business logic that contains custom rules or algorithms that handle the exchange of information between a database and a user interface. Business logic is the part of a computer program that contains the information (i.e., in the form of business rules) that defines or constrains how a business operates. Such business rules are operational policies that are usually expressed in true or false binaries. Business logic is seen in the workflows that the business logic supports, such as in sequences or steps that specify in detail the proper flow of information or data, and therefore decision-making. The technical layer is used to model the technology architecture of an enterprise. The technical layer is the structure and interaction of the platform services, and logical and physical technology components.

Enterprise software, further known as enterprise application software (EAS), is computer software used to satisfy needs of an organization rather than individual users. EAS is one example of EDA software. Such organizations include businesses, schools, interest-based user groups, clubs, charities, and governments. Enterprise software is a part of a (computer-based) information system; a collection of such software is called an enterprise system. These systems handle a chunk of operations in an organization with the aim of enhancing the business and management reporting tasks. The systems process the information at a relatively high speed and deploy the information across a variety of networks. Services provided by enterprise software are typically business-oriented tools, such as online shopping, and online payment processing, interactive product catalogue, automated billing systems, security, business process management, enterprise content management, information technology (IT) service management, customer relationship management, enterprise resource planning, business intelligence, project management, collaboration, human resource management, manufacturing, occupational health and safety, enterprise application integration, and enterprise forms automation.

In some embodiments, the business layer and the technical layer are separated. In some embodiments, the event transformer supports the separation of the business layer and the technical layer. In some embodiments, the separation of the business layer and the technical layer supports quicker implementation of new business use models or rules. In some embodiments, the event transformer reduces the time to implement new business use solutions and reduces the cost of development by allowing code reuse.

In some embodiments, based on business logic the collected event messages are grouped into frames. Frames are an artificial intelligence data structure used to divide knowledge into substructures by representing stereotyped situations. Frames are the primary data structure used in artificial intelligence frame language. Frames are stored as ontologies of sets. In computer science and information science, an ontology encompasses a representation, formal naming and definition of the categories, properties and relations between the concepts, data and entities that substantiate one, many, or all domains of discourse. An ontology is a way of showing the properties of a subject area and how the properties are related, by defining a set of concepts and categories that represent the subject. Frames are further an extensive part of knowledge representation and reasoning schemes. Structural representations assemble facts about a particular object and event message types and arrange the event message types into a large taxonomic hierarchy.

In some embodiments, the behavior of the event transformer is modified on the fly without changing software code or stopping the server. In some embodiments, the event transformer is configured to switch between many data sources and data sinks. In computing, a sink, event sink or data sink is a class or function designed to receive incoming event messages from another object or function.

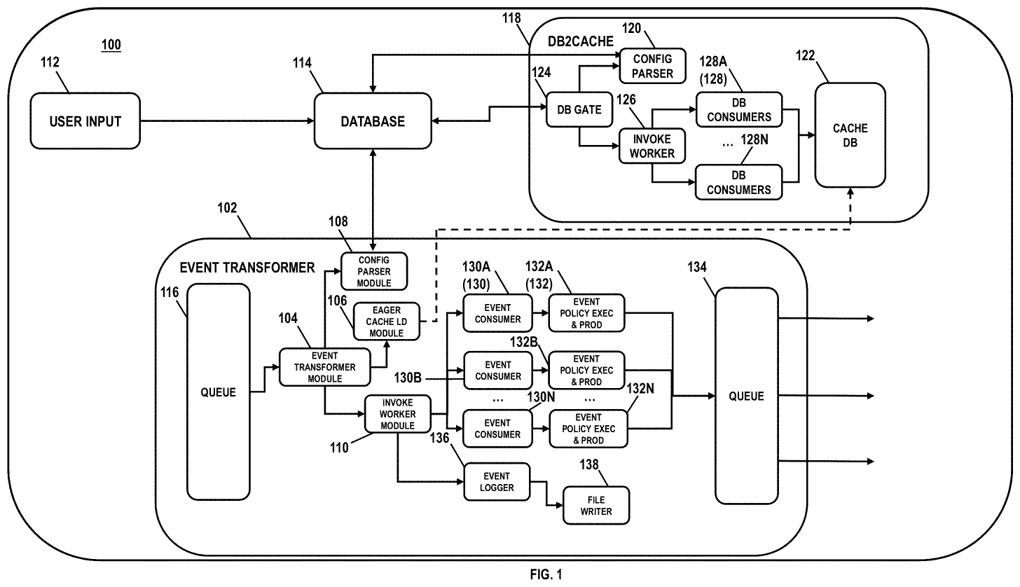

FIG. 1 is a block diagram representation of an event transformer system 100, in accordance with some embodiments.

Event transformer system 100 includes an event transformer 102 that includes an event transformer module 104, Eager cache loader module 106, configuration parser module 108, and invoke worker module 110. Event transformer system 100 is a software application that applies rules, policies, or functions to incoming event frame(s). Event transformer system 100 is used in systems management tools to apply a policy to an event frame(s). In some embodiments, event transformer system 100 is a part of an EDA platform.

In some embodiments, a service layer of event transformer system 100 creates multiple event transformers 102 based on a received user-defined configuration file inputted by a user at user input 112. In some embodiments, user input (UI) 112 (e.g., human—machine interface) is the part of event transformer 102 that handles human—machine interaction. Additionally or alternatively, UI 112 is a membrane switch, rubber keypad or touchscreen. In some embodiments, UIs are composed of one or more layers, including a human-machine interface (HMI) that interfaces machines with physical input hardware such as keyboards, mice, or game pads, and output hardware such as computer monitors, speakers, and printers. In some embodiments, UI 112 is a graphical user interface (GUI), which is composed of a tactile UI and a visual UI capable of displaying graphics. Additionally or alternatively, sound is added to the GUI for a multimedia user interface (MUI).

In some embodiments, event transformer(s) 102 embeds policies within incoming event message frame(s). In some embodiments, event transformer(s) 102 further correlates event message frame(s) to policies, within event policy execute & produce module 132A, 132B, . . . 132N (where N is a non-negative integer) (hereinafter event policy execute & produce module 132). In some embodiments, event transformer 102 is pluggable in nature. In computing, a plug-in (or plugin, add-in, addin, add-on, or addon) is a software component that adds a specific feature to an existing computer program and enables customization. In some embodiments, event transformer(s) 102 are scalable and are configured to be scaled in every use. In some embodiments, event transformer(s) 102 quickly embed one or more policy rules based on one or more use-cases to event message frame(s) based on multi-layer caching. In computing, a cache is a hardware or software component that stores data so that future requests for that data are served faster. The data stored in a cache is the result of an earlier computation or a copy of data stored elsewhere. Cache hits are served by reading data from the cache, which is faster than re-computing a result or reading from a slower data store; thus, the more requests that are served from the cache, the faster the system performs.

Event transformer module 104 is the master process within event transformer(s) 102 and responsible for initiating configuration parser module 108 and invoke worker module 110. In some embodiments, event transformer module 104 delegates tasks, based upon the user-defined configuration file, retrieved by configuration parser module 108. Event transformer module 104 then delegates all tasks to all other modules within event transformer(s) 102. In some embodiments, the startup of configuration parser module 108 and invoke worker module 110 is performed sequentially. In some embodiments, the startup is performed concomitantly. Event transformer module 104 further receives event message frame(s) from a queue 116. In some embodiments, the event message frame(s) are provided by one or more event gates upstream of event transformer(s) 102. Event message frame(s) are from online data sources, offline data sources, streaming data sources and batch data sources.

In some embodiments, event transformer(s) 102 begin operation as a daemon process and loads cache database 118 with business logic defined in master database 114. A cache database is a system that caches (e.g., saves) results from a database, in order to return the result faster next time. There are two types of database cache: (1) an internal cache that keep results ready that that internal cache thinks the user might need based on usage patterns. (2) A query cache stores results when a query is made more than once (e.g., for instance for a configuration file) and the result is cached and returned from random access memory (RAM). When the RAM runs out, the least recently used query is deleted to make space for new ones. When the underlying data changes, either on a table or row/document level, depending on the database, the cache is cleared.

Master database 114 is the configuration database storing the user-defined configuration file in a server, such as a structured query language (SQL) server. Master database 114 contains information on all the databases that exist on the server(s), including the physical database files and their locations. Master database 114 further contains the server's configuration settings and login account information. The following list outlines the information contained in master database 114: (1) server registrations and remote logins, (2) local databases and database files, (3) login accounts, (4) processes and locks, (5) server(s) configuration settings.

Persistent cache 122 is information stored in permanent memory, so data is not lost after a system restart or system crash as the data is when the data was stored in cache memory. In some embodiments, the data in persistent cache 122 is queried by event consumers 130A, 130B . . . 130N (where N is a non-negative integer) (hereinafter event consumers 130) through Eager cache load module 106. In some embodiments, Eager mode, or Eager loading, makes a single query on a database and loads the related policies based upon the query. This is in contrast to Lazy mode that makes multiple database queries to load the related policies. Cache sharing allows each data cache to share the data cache contents with the other caches and avoid duplicate caching.

In some embodiments, database gate module 124 receives data from one or more databases including master database 114 containing business logic and business data. In some embodiments, based on the user-defined configuration file forwarded by configuration parser module 120, database gate module 124 instructs invoke worker module 126 to create one or more database consumer module(s) 128A . . . 128N (where N is a non-negative integer) (hereinafter database consumer module 128). In some embodiments, database consumers frame data (such as a data model) and send to persistent cache 122.

In some embodiments, within event transformer(s) 102 configuration parser module 108 queries master database 114 for the user-defined configuration file. In some embodiments, the user-defined configuration file is related to technical aspects regarding the data sources, data sinks, and the policy definitions that are passed downstream. In some embodiments, event transformer module 104 is configured to parse the configuration file to all other modules within event transformer 102. In some embodiments, based on the configuration file, invoke worker module 110 spawns one or more event consumer(s) 130. In some embodiments, the configuration file includes a predefined data source and data sink. In some embodiments, the configuration file is inputted, modified, and controlled by a user through user input 112. In some embodiments, the user inputs, modifies, and controls the configuration file in real time. In some embodiments, master database 114 and/or user input 112 are located within a correlation engine and policy manager (CPE).

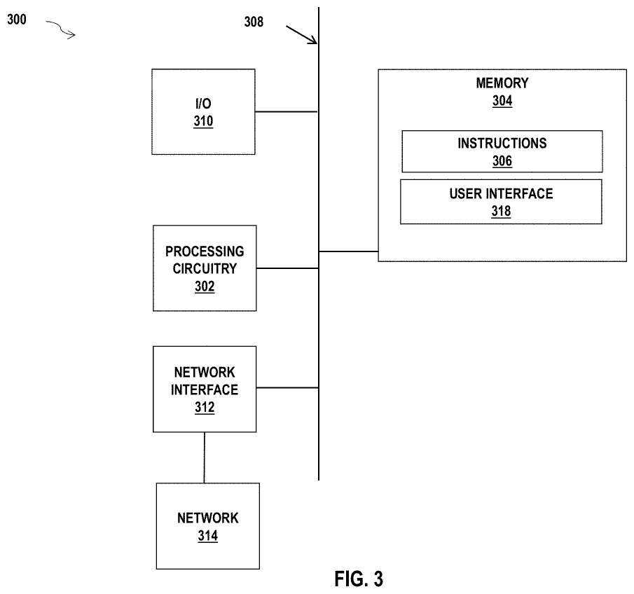

In some embodiments, based on a number of data sources and data sinks configuration parser module 108 forwards to invoke worker module 110 an instruction to spawn multiprocessing workers or event consumers 130 on each core of a system with a shared queue 134. In some embodiments, core refers to a central processing unit (CPU), further called a central processor, main processor or just processor and is the electronic circuitry that executes instructions comprising a computer program. In some embodiments, the core is processing circuitry 302 of FIG. 3. The core performs basic arithmetic, logic, controlling, and input/output (I/O) operations specified by the instructions in a program. In some embodiments, the system is a group of computers or cores that are linked and function together, such as a computer network or computer cluster. In some embodiments, shared queue 134 is for data sharing between event consumers 130.

In some embodiments, configuration parser module 108 is a data model parser that parses the configuration file. The data model parser is a parsing library and not a validation library. In other words, the data model parser assures the types and constraints of the output model, not the input data based on the configuration file. In some embodiments, parameters are obtained and set based upon the configuration file. In some embodiments, the configuration file details read, write and execute permissions for event transformer module 104, invoke worker module 110 and event consumers 130.

In some embodiments, event consumers 130 write event message frame(s) to event policy execute and produce modules 132. In some embodiments, the business policy retrieved from cache database 118 by Eager cache loader module 106 is applied to event message frame(s) already containing framed event message(s) by event policy execute and produce modules 132. In some embodiments, the event message frame(s) are transformed with business policy and thus instruction at the data sink in processing the event message frame(s). In some embodiments, event policy execute and produce module(s) 132 perform the correlation of event frame(s) with the business policy as per the configuration file.

In some embodiments, the event execute and produce modules 132 distribute the newly policy loaded event message frame(s) downstream for further processing. In some embodiments, any change made to the business logic or configuration file, for example by a user at user input 112, is made in real time, on the fly, and reflected in persistent cache 122. In some embodiments, the updated business logic is applied to all upcoming event message frame(s) in real time.

In some embodiments, a unique event identification is added to every event message frame. In some embodiments, every event consumer 130 has a unique identification. In some embodiments, one or more event consumers 130 are disabled, refreshed or suspended based upon the unique identification. In some embodiments, each event consumer 130 allows for multiple data sources and customized configurations. In some embodiments, based on the configuration file, event consumers 130 consume event messages from the configuration file designated data source and send the event message to the data sink; shared queue 134.

In some embodiments, shared queue 134 is an asynchronous messaging library, aimed at use in distributed or concurrent applications. In some embodiments, shared queue 134 provides a message queue, but unlike message-oriented middleware, a shared queue 134 runs without a dedicated message broker. In some embodiments, each event consumer 130 includes a data source and data sink definition to which the event consumer 130 attaches read and write data.

In some embodiments, event logger 136 reads shared queue 134 that is populated by event consumers 130 and logs the information to a file. In some embodiments, file writer 138 writes logs of event enricher 102 to a file. In some embodiments, file writer 138 maintains rolling logs based on timestamp and size. Event transformer system 100 is used in systems management tools to aggregate, normalize and analyze the event log data, using predictive analytics and fuzzy logic to alert the systems administrator when there is a problem.

In some embodiments, the qualified policy definitions are available in Eager cache load module 106 of event transformer 102 as defined by the business policies. In some embodiments, event message frames are processed by event policy execute and produce modules 132 using CEP or pattern matching. In some embodiments, event policy execute and produce modules 132 perform one or more operations one the even message frames such as mapping, filtering, windowing, interpolation, reduction, accumulation or aggregation. In some embodiments, based on the applied policy, notification of rejection or success is generated for the set of event frames. In some embodiments, the event frames are sent over message queue 134.

In some embodiments, the business layer is a data layer that is utilized by the internal modules of event transformer 102 for correlation of data with respect to the policy. In some embodiments, the business layer consists of a data like network configuration, topological information, state transitions, policies, and other suitable data in accordance with some embodiments which are utilized for enrichment of the input events, or by event transformer 102 for correlation of the events with respect to the policies.

In some embodiments, a technical layer is that data which includes the technical configurations of the event transformer system components. For example; scaling the event transformer system components, switch the components on/off based upon the policies, or even act on the states of the components like SUSPEND, RESTART, and other suitable actions in accordance with some embodiments.

In some embodiments, event transformer system 100 receives events and correlates the events with respect to rules in policies. In some embodiments, event transformer system 100 is connected to an event enricher to receive enriched (e.g., event frames supplemented with related events and data) events that are further correlated to the policies through the business data layer. That is, the original event frame and the additional events coupled with the original event frame are also correlated with policies based on the business data layer. In some embodiments, for the rule-based policies, a correlation is based on the rules (such as a user/vendor implementing a proprietary model into event transformer system 100). In some embodiments, the rule-based policies are plugged into the event transformer system 100 to make the correlations. In some embodiments, the correlation assists in defining actions. In some embodiments, for rule-based policies, actions are the decisions which are further propagated to the next component in the architecture (e.g., for execution or relay to other modules for execution).

In some embodiments, examples of policies include rule based policies where a user/vendor apply complex policies which are series of patterns embedded within each other. For example; in response to event A occurring 2 times, followed by event B occurring at least once, followed by event C occurring not more than 5 times with the entire pattern within a window period of 1 minute. In some embodiments, A=2, B>1, C<=5 is an example of a complex pattern, with multiple use cases where A, B, and C are events. In some embodiments, using complex event processing, policy is solved by the event transformer system 100. In some embodiments, event transformer system 100 uses multiple libraries which when exposed to the user, are a plug and play type system where a user groups events, or maps events to various functionalities, and these actions are part of the policy.

In some embodiments, policies are of another type such as alarm clearance type policies where when system is repaired or operate properly, a clearance alarm is activated. In some embodiments, CEP complex event-based policies are implemented. In some embodiments, change management system policies are used when actions are not to be taken on a network system. In some embodiments, a policy includes an anomaly detection system within a particular constraint (e.g., window time, with respect to states in the system) when any anomalous event is detected, appropriate action is taken.

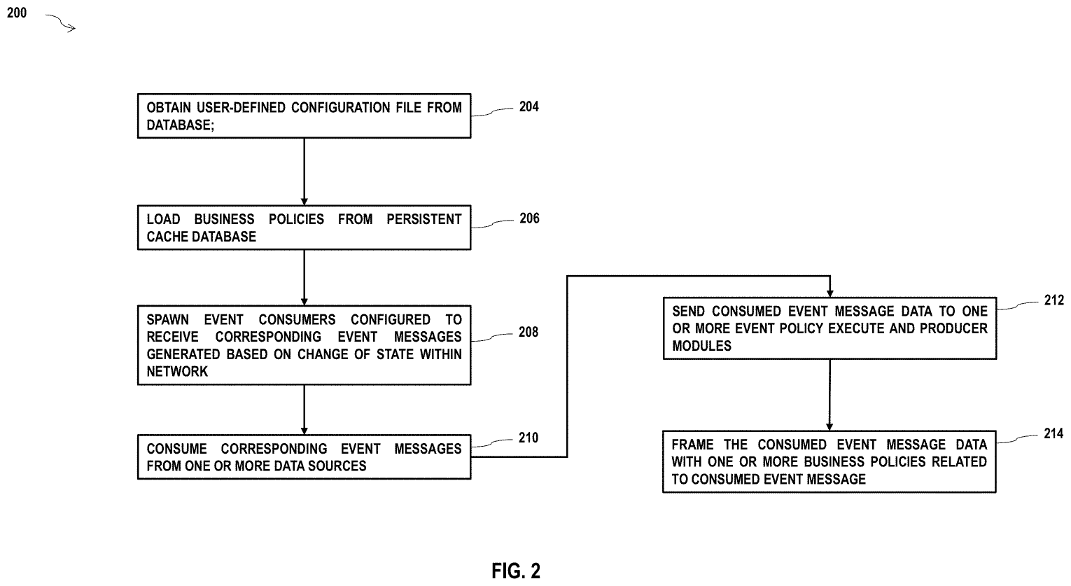

FIG. 2 is a flow diagram for a method of transforming event message frame(s) 200, in accordance with some embodiments.

Method 200 is configured to be used to transform event message frame(s). Method 200 is configured to be used in a CPE, such as event transformer system 100, to handle multiple data sources and multiple data source types. The sequence in which the operations of method 200 are depicted in FIG. 2 is for illustration only; the operations of method 200 are capable of being executed in sequences that differ from that depicted in FIG. 2. In some embodiments, operations in addition to those depicted in FIG. 2 are performed before, between, during, and/or after the operations depicted in FIG. 2.

In some embodiments, one or more of the operations of method 200 are a subset of operations of a method transforming event message frame(s). In various embodiments, one or more of the operations of method 200 are performed by using one or more processors, e.g., processing circuitry 302 discussed below with respect to event transformer processing system 300 and FIG. 3.

At operation 204 of method 200, a configuration parser module, such as configuration parser module 108 obtains a user-defined configuration file from a database. Process flows from operation 204 to operation 206.

At operation 206 of method 200, an Eager cache load module such as Eager cache load module 106, loads business policies from a persistent cache database, such as persistent cache database 122. Process flows from operation 206 to operation 208.

At operation 208 of method 200, an invoke worker module, such as invoke worker module 110, spawns, based on the user-defined configuration file, event consumers, such as event consumers 130, configured to receive corresponding event messages generated based on a change of state within a network. Process flows from operation 208 to operation 210.

At operation 210 of method 200, event consumer module(s), such as event consumer modules 130, consume the corresponding event messages from one or more data sources. Process flows from operation 210 to operation 212.

At operation 212 of method 200, event consumer module(s), such as event consumer module(s) 130, send consumed event message data to one or more event policy execute and producer modules, such as event policy execute and producer module 132. Process flows from operation 212 to operation 214.

At operation 214 of method 200, event policy execute and producer module, such as event execute and producer module 132, frames one or more business policies with the event message frame.

FIG. 3 is a block diagram of event transformer processing system 300 in accordance with some embodiments. In some embodiments, event transformer processing system 300 is a general purpose computing device including a hardware processing circuitry 302 and a non-transitory, computer-readable storage medium 304. Storage medium 304, amongst other things, is encoded with, i.e., stores, computer program code 306, i.e., a set of executable instructions such as a correlation engine and policy manager. Execution of instructions 306 by hardware processing circuitry 302 represents (at least in part) an event transformer tool which implements a portion or all of the methods, such as method 200, described herein in accordance with one or more embodiments (hereinafter, the noted processes and/or methods).

Hardware processing circuitry 302 is electrically coupled to a computer-readable storage medium 304 via a bus 308. Hardware processing circuitry 302 is further electrically coupled to an I/O interface 310 by bus 308. A network interface 312 is further electrically connected to processing circuitry 302 via bus 308. Network interface 312 is connected to a network 314, so that processing circuitry 302 and computer-readable storage medium 304 are capable of connecting to external elements via network 314. processing circuitry 302 is configured to execute computer program code 306 encoded in computer-readable storage medium 304 in order to cause event transformer processing system 300 to be usable for performing a portion or all of the noted processes and/or methods, such as method 200, of FIG. 2. In one or more embodiments, processing circuitry 302 is a central processing unit (CPU), a multi-processor, a distributed processing system, an application specific integrated circuit (ASIC), and/or a suitable processing unit.

In one or more embodiments, computer-readable storage medium 304 is an electronic, magnetic, optical, electromagnetic, infrared, and/or a semiconductor system (or apparatus or device). For example, computer-readable storage medium 304 includes a semiconductor or solid-state memory, a magnetic tape, a removable computer diskette, a random access memory (RAM), a read-memory (ROM), a rigid magnetic disk, and/or an optical disk. In one or more embodiments using optical disks, computer-readable storage medium 304 includes a compact disk-read memory (CD-ROM), a compact disk-read/write (CD-R/W), and/or a digital video disc (DVD).

In one or more embodiments, storage medium 304 stores computer program code 306 configured to cause event transformer processing system 300 to be usable for performing a portion or all of the noted processes and/or methods. In one or more embodiments, storage medium 304 further stores information, such an event transformer algorithm which facilitates performing a portion or all of the noted processes and/or methods.

Event transformer processing system 300 includes I/O interface 310 that is like user input 112. I/O interface 310 is coupled to external circuitry. In one or more embodiments, I/O interface 310 includes a keyboard, keypad, mouse, trackball, trackpad, touchscreen, cursor direction keys and/or other suitable I/O interfaces are within the contemplated scope of the disclosure for communicating information and commands to processing circuitry 302.

Event transformer processing system 300 further includes network interface 312 coupled to processing circuitry 302. Network interface 312 allows data adaptor processing system 300 to communicate with network 314, to which one or more other computer systems are connected. Network interface 312 includes wireless network interfaces such as BLUETOOTH, WIFI, WIMAX, GPRS, or WCDMA; or wired network interfaces such as ETHERNET, USB, or IEEE-864. In one or more embodiments, a portion or all of noted processes and/or methods, is implemented in two or more event transformer processing system 300.

Event transformer processing system 300 is configured to receive information through I/O interface 310. The information received through I/O interface 310 includes one or more of instructions, data, and/or other parameters for processing by processing circuitry 302. The information is transferred to processing circuitry 302 via bus 308. Event transformer processing system 300 is configured to receive information related to a UI through I/O interface 310. The information is stored in computer-readable medium 304 as user interface (UI) 318.

In some embodiments, a portion or all of the noted processes and/or methods is implemented as a standalone software application for execution by processing circuitry. In some embodiments, a portion or all of the noted processes and/or methods is implemented as a software application that is a part of an additional software application. In some embodiments, a portion or all of the noted processes and/or methods is implemented as a plug-in to a software application.

In some embodiments, the processes are realized as functions of a program stored in a non-transitory computer readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

In some embodiments, a system includes processing circuitry; and a memory connected to the processing circuitry, wherein the memory is configured to store executable instructions that, when executed by the processing circuitry, facilitate performance of operations, including: receive an event message frame from a data source, wherein the event message frame is generated by one or more state changes within a network operatively connected to the system; correlate one or more business policies based the event message frame; apply the one or more operations to the event message frame based on the one or more business policies to create a transformed event message frame; and route the transformed event message frame to a message queue.

In some embodiments, the instructions further including receive the one or more business policies from a cache database.

In some embodiments, the business policies are one or more of: a complex event processing policy; an alarm detection policy; a change management policy; a prediction policy; and a health check policy.

In some embodiments, the one or more operations are one or more of: grouping; mapping; filtering; windowing; interpolation; reduce; accumulation; and aggregation.

In some embodiments, the instructions further including: receive notification of rejection of the event message frame based on one or more correlated policies.

In some embodiments, the instructions further including: receive notification of success of the event message frame based on one or more correlated policies.

In some embodiments, a method includes: obtaining a user-defined configuration file from a database; loading business policies into a persistent cache database; spawning, based on the user-defined configuration file, event consumers configured to receive corresponding event message frames received from one or more data sources; consuming, by the event consumers, the corresponding event message frames from the one or more data sources; sending, by the event consumers, consumed event message frames to one or more event policy execution and producers; and framing, by the one or more execution and producers, the consumed event message frames with one or more business policies related to the consumed event message frame.

In some embodiments, the method further includes: receiving the corresponding event message frames from the one or more data sources, wherein the corresponding event message frames are generated by one or more state changes.

In some embodiments, the method further includes: correlating the one or more business policies based a corresponding event message frame.

In some embodiments, the method further includes: applying one or more operations to a corresponding event message frame based on the one or more business policies to create a transformed event message frame.

In some embodiments, the method further includes: routing the transformed event message frame to a message queue.

In some embodiments, the method further includes: receiving notification of rejection of the event message frame based on one or more correlated policies.

In some embodiments, the method further includes: receiving notification of success of the event message frame based on one or more correlated policies.

In some embodiments, a device includes: a non-transitory, tangible computer readable storage medium storing a computer program, wherein the computer program contains instructions that when executed, cause the device to perform operations including: load a cache database with business policies stored in a master database; convert business policies into a data model; load the data model into a persistent cache database; obtain one or more business policies from the persistent cache database based on a received event message frame; correlate an event message frame with a business policy; and apply the business policy to event message frame.

In some embodiments, the operations further include: receive event message frames from the one or more data sources.

In some embodiments, the operations further include: correlate a plurality of business policies based a corresponding event message frame.

In some embodiments, the operations further includes: apply one or more operations to a corresponding event message frame based on one or more business policies to create a transformed event message frame.

In some embodiments, the operations further include: route the transformed event message frame to a message queue.

In some embodiments, the operations further include: receive notification of rejection of the event message frame based on one or more correlated policies.

In some embodiments, the operations further include: receive notification of success of the event message frame based on one or more correlated policies.

The foregoing outlines features of several embodiments so that those skilled in the art better understand the aspects of the present disclosure. Those skilled in the art should appreciate that they readily use the present disclosure as a basis for designing or modifying other processes and structures for carrying out the same purposes and/or achieving the same advantages of the embodiments introduced herein. Those skilled in the art should further realize that such equivalent constructions do not depart from the spirit and scope of the present disclosure, and that they make various changes, substitutions, and alterations herein without departing from the spirit and scope of the present disclosure.

What is claimed is:

1. A system, comprising:
processing circuitry; and
a memory connected to the processing circuitry, wherein the memory is configured to store executable instructions that, when executed by the processing circuitry, facilitate performance of operations, comprising:
receive an event message frame from a data source, wherein the event message frame is generated by one or more state changes within a network operatively connected to the system;
correlate one or more business policies based the event message frame;
apply the one or more operations to the event message frame based on the one or more business policies to create a transformed event message frame; and
route the transformed event message frame to a message queue.

2. The system of claim 1, wherein the instructions further comprise:
receive the one or more business policies from a cache database.

3. The system of claim 1, wherein the business policies are one or more of:
a complex event processing policy;
an alarm detection policy;
a change management policy;
a prediction policy; and
a health check policy.

4. The system of claim 3, wherein the one or more operations are one or more of:
grouping;
mapping;
filtering;
windowing;
interpolation;
reduce;
accumulation; and
aggregation.

5. The system of claim 1, wherein the instructions further comprise:
receive notification of rejection of the event message frame based on one or more correlated policies.

6. The system of claim 1, wherein the instructions further comprise:
receive notification of success of the event message frame based on one or more correlated policies.

7. A method, comprising:
obtaining a user-defined configuration file from a database;
loading business policies into a persistent cache database;
spawning, based on the user-defined configuration file, event consumers configured to receive corresponding event message frames received from one or more data sources;
consuming, by the event consumers, the corresponding event message frames from the one or more data sources;
sending, by the event consumers, consumed event message frames to one or more event policy execution and producers; and
framing, by the one or more execution and producers, the consumed event message frames with one or more business policies related to the consumed event message frame.

8. The method of claim 7, further comprising:
receiving the corresponding event message frames from the one or more data sources, wherein the corresponding event message frames are generated by one or more state changes.

9. The method of claim 8, further comprising:
correlating the one or more business policies based a corresponding event message frame.

10. The method of claim 9, further comprising:
applying one or more operations to a corresponding event message frame based on the one or more business policies to create a transformed event message frame.

11. The method of claim 10, further comprising:
routing the transformed event message frame to a message queue.

12. The method of claim 10, further comprising:
receiving notification of rejection of the event message frame based on one or more correlated policies.

13. The method of claim 10, further comprising:
receiving notification of success of the event message frame based on one or more correlated policies.

14. A device comprising:
a non-transitory, tangible computer readable storage medium storing a computer program, wherein the computer program contains instructions that when executed, cause the device to perform operations comprising:
load a cache database with business policies stored in a master database;
convert business policies into a data model;
load the data model into a persistent cache database;
obtain one or more business policies from the persistent cache database based on a received event message frame;
correlate an event message frame with a business policy; and
apply the business policy to event message frame.

15. The device of claim 14, wherein the operations further comprise:
receive event message frames from the one or more data sources.

16. The device of claim 15, wherein the operations further comprise:
correlate a plurality of business policies based a corresponding event message frame.

17. The device of claim 15, wherein the operations further comprise:
apply one or more operations to a corresponding event message frame based on one or more business policies to create a transformed event message frame.

18. The device of claim 17, wherein the operations further comprise:
route the transformed event message frame to a message queue.

19. The device of claim 18, wherein the operations further comprise:
receive notification of rejection of the event message frame based on one or more correlated policies.

20. The device of claim 18, wherein the operations further comprise:
receive notification of success of the event message frame based on one or more correlated policies.
